(19) United States
(12) Patent Application Publication
(10) Pub. No.: US 2022/0038806 A1
(43) Pub. Date: Feb. 3, 2022

(54) EAR PLUG HAVING PRESSURE-ADJUSTING COMPARTMENT AND FORMATION METHOD FOR SAME

(71) Applicant: CONCRAFT HOLDING CO., LTD., Grand Cayman (KY)

(72) Inventor: Lei CHENG, Kunshan City (CN)

(21) Appl. No.: 17/014,241

(22) Filed: Sep. 8, 2020

(30) Foreign Application Priority Data
Aug. 3, 2020 (TW) 109126426

(51) Int. Cl. H04R 1/10; B29C 45/00

(52) U.S. Cl. CPC H04R 1/1016; B29K 2083/00; B29C 45/006

(57) ABSTRACT

An ear plug having a pressure-adjusting compartment and a formation method. The ear plug is mounted on an earphone so as to be placed into a human auditory canal. The ear plug employs a first formation step for forming an outer main body, the ear plug further employs a second formation step for forming an inner main body, such that the inner main body has formed thereon a mounting portion and an umbrella portion having at least one second air conducting hole, and the ear plug further employs an integration step to make at least one pressure-adjusting compartment between the mounting portion, the audio out portion, the umbrella portion and the outer wall portion, which is respectively and mutually communicated with the first air conducting hole and the second air conducting hole, thereby balancing air pressures in the human auditory canal and outside the earphone via the pressure-adjusting compartment.

### BACKGROUND OF THE INVENTION

### a) Field of the Invention

The present invention relates to an ear plug and, more particularly, to an ear plug to be mounted on an earphone and worn inside a human auditory canal, so as to improve wearing comfort by adjusting air pressure.

### b) Description of the Prior Art

Earphones are divided into wireless earphones and wired earphones; as suggested by their names, wireless earphones transmit voices wirelessly, while wired earphones transmit voices via a wire.

For both wireless earphones and wired earphones, an ear plug is usually provided at one end of an earphone which is inserted into the human auditory canal so as to improve wearing comfort, because the earphone body is usually made by plastic injection molding using a hard material to achieve durability. The ear canal could be damaged if the hard material is directly inserted into the human auditory canal, which is also inadequate for wearing for a long period of time. Therefore, earphones are mostly added with ear plugs formed by using a soft material, so as to prevent the earphones from chafing with the human auditory canal.

In addition, in order to improve audio played by an earphone in the human auditory canal and enable the audio to completely enter into the human auditory canal, an ear plug has to be thoroughly fitted to the human auditory canal, so as to prevent external noises from entering into the human auditory canal via a gap. As a result, while the ear plug increases airtightness inside the human auditory canal, it also leads to physical discomfort (such as dizziness and the like) caused by excessive air pressure inside the human auditory canal.

To improve the situation, some of the current earphones are internally provided with an air pressure adjusting mechanism, as disclosed in Chinese Patent Publication No. CN109246524A and Chinese Gazette No. CN206433116U, both of which have disclosed designs for achieving air pressure adjustment inside an earphone. However, such designs not only make earphone structures more complicated, but also increase production cost of earphones. Therefore, some earphones have a pressure release hole provided on the ear plug, so as to release the air pressure inside human auditory canal outwards via the ear plug, as disclosed in Taiwan Patent No. 1599234. Although such a design can effectively cut down production cost of an earphone and simplify earphone mechanism, during actual wearing, such an ear plug is prone to being restricted by the size of human auditory canal upon entering into the human auditory canal, causing the ear plug to be completely sealed and preventing the air pressure inside the human auditory canal from being outwardly released via the pressure release hole, which equivalently causes discomfort to the human auditory canal.

Accordingly, the issue to be solved by the present application is how to provide an ear plug for effectively adjusting air pressure so as to improve wearing comfort during wearing.

### SUMMARY OF THE INVENTION

The objective of the present invention is to provide an ear plug, in particular, an ear plug to be mounted on an earphone and worn inside a human auditory canal, so as to improve wearing comfort by adjusting air pressure.

To achieve the aforesaid purpose, the present invention firstly provides an ear plug having a pressure-adjusting compartment, which is mounted on an earphone for being placed into a human auditory canal, wherein the ear plug comprises an outer main body and an inner main body provided in the outer main body. The outer main body has an annular audio out portion, an outer wall portion enclosed around an outer side of the audio out portion and used for being fitted to the human auditory canal, and a connection portion connected between the audio out portion and the outer wall portion, such that the outer main body has a hollow compartment formed therein, and the connection portion has at least one first air conducting hole formed thereon. The inner main body has a mounting portion for connecting to the earphone and an umbrella portion outwardly extended from the mounting portion and enclosed around an outer side of the mounting portion, and the umbrella portion has at least one second air conducting hole formed thereon. The mounting portion is mutually connected to an end surface of the audio out portion adjacent thereto, and the umbrella portion has an end surface thereof mutually connected to an inner wall surface of the outer wall portion, such that at least one pressure-adjusting compartment respectively and mutually communicated with the first air conducting hole and the second air conducting hole is formed between the outer main body and the inner main body; when the ear plug is inserted into the human auditory canal, the ear plug is capable of balancing an air pressure inside the human auditory canal with the external air pressure sequentially via the first air conducting hole, the pressure-adjusting compartment and the second air conducting hole.

In an embodiment, the audio out portion has a first audio outlet formed in the center thereof, while the mounting portion has thereon a second audio outlet located in the same center as the first audio outlet, the second audio outlet has a fixing groove formed therein, and the fixing groove has a diameter greater than a diameter of the second audio outlet.

In another embodiment, the umbrella portion is further provided thereon with at least two partitions extended towards an internal portion of the pressure-adjusting compartment, and each of the partitions is respectively connected to the mounting portion, the audio out portion, the connection portion and the outer wall portion, so as to divide the pressure-adjusting compartment into two independent compartments by using the two partitions, and each of the independent compartments is respectively and mutually communicated with at least one of the first air conducting holes and at least one of the second air conducting holes.

In yet another embodiment, the first air conducting hole and the second air conducting hole are not located in the same center, such that the first air conducting hole and the second air conducting hole are mutually separated from each other.

In a further embodiment, the first air conducting hole and the second air conducting hole have a diameter between 0.1-1 mm, and the pressure-adjusting compartment has a volume between 10-100 microliters.

To achieve the aforesaid purpose, the present invention further provides a formation method for forming a pressure-adjusting compartment on an ear plug, comprising: a first formation step for forming an outer main body, a second formation step for forming an inner main body and an integration step. The first formation step firstly provides a first mold having a first upper mold base and a first lower mold base, and forms a first formation space inside the first mold, the outer main body is formed after injecting a formation material into the first formation space, such that the outer main body has an annular audio out portion, an outer wall portion enclosed around an outer side of the audio out portion and used for being fitted to the human auditory canal, and a connection portion connected between the audio out portion and the outer wall portion, the outer main body has a hollow compartment formed therein, and the connection portion has at least one first air conducting hole formed thereon. The second formation step further provides a second mold having a second upper mold base and a second lower mold base, and forms a second formation space inside the second mold, the inner main body is formed after injecting a formation material into the second formation space, such that the inner main body has a mounting portion and an umbrella portion outwardly extended from the mounting portion and enclosed around an outer side of the mounting portion, and the umbrella portion has at least one second air conducting hole formed thereon. The integration step firstly removes the first lower mold base, so as to keep the outer main body on the first upper mold base, and then removes the second upper mold base, so as to keep the inner main body on the second lower mold base, subsequently closing the first upper mold base with the second lower mold base, such that mutually adjacent end surfaces of the audio out portion and the mounting portion are mutually joined, the umbrella portion has one end surface thereof mutually joined with an inner wall surface of the outer wall portion, so as to form at least one of the pressure-adjusting compartment respectively and mutually communicated with the first air conducting hole and the second air conducting hole between the outer main body and the inner main body, and the ear plug is formed by means of the outer main body and the inner main body.

In one embodiment, the formation material is silicone.

In another embodiment, in the integration step, the audio out portion, the mounting portion, the umbrella portion and the inner wall surface are mutually joined by means of secondary vulcanization.

In yet another embodiment, the first air conducting hole and the second air conducting hole are not located in the same center, such that the first air conducting hole and the second air conducting hole are mutually separated from each other.

In a further embodiment, the first air conducting hole and the second air conducting hole have a diameter between 0.1-1 mm, and the pressure-adjusting compartment has a volume between 10-100 microliters.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 is a three-dimensional schematic view showing an ear plug according to the present invention.

FIG. 2 is a planar view showing the ear plug in a disassembled state according to the present invention.

FIG. 3 is a front schematic view showing the ear plug according to the present invention.

FIG. 4 is a rear schematic view showing the ear plug according to the present invention.

FIG. 5 is a first sectional schematic view showing the ear plug according to the present invention.

FIG. 6 is a second sectional schematic view showing the ear plug according to the present invention.

FIG. 7 is a first sectional schematic view showing the ear plug being mounted on an earphone and worn inside human auditory canal according to the present invention.

FIG. 8 is a second sectional schematic view showing the ear plug being mounted on an earphone and worn inside human auditory canal according to the present invention.

FIG. 9 is a process schematic view showing a manufacturing method according to the present invention.

FIG. 10 is a sectional schematic view showing a first mold according to the present invention.

FIG. 11 is a sectional schematic view showing a second mold according to the present invention.

FIG. 12 is a sectional schematic view showing a first upper mold base and a second lower mold base in a separated state according to the present invention.

FIG. 13 is a sectional schematic view showing the first upper mold base and the second lower mold base in a closed state according to the present invention.

FIG. 14 is a sectional schematic view showing a pressure-adjusting compartment having two independent spaces formed therein according to the present invention.

FIG. 15 is a sectional schematic view showing a pressure-adjusting compartment having three independent spaces formed therein according to the present invention.

### DETAILED DESCRIPTION OF THE PREFERRED EMBODIMENTS

The detailed explanations and technical contents of the present invention are provided along with accompanying drawings as follows:

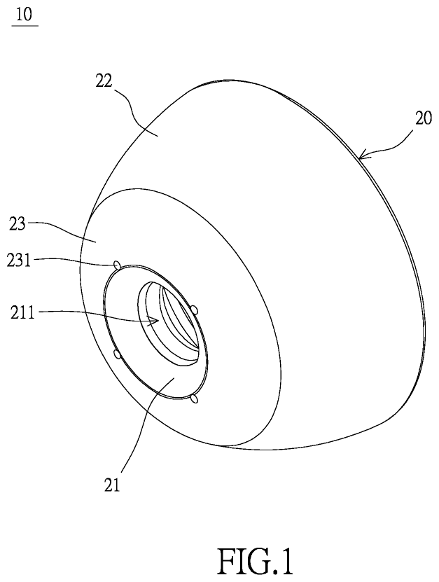

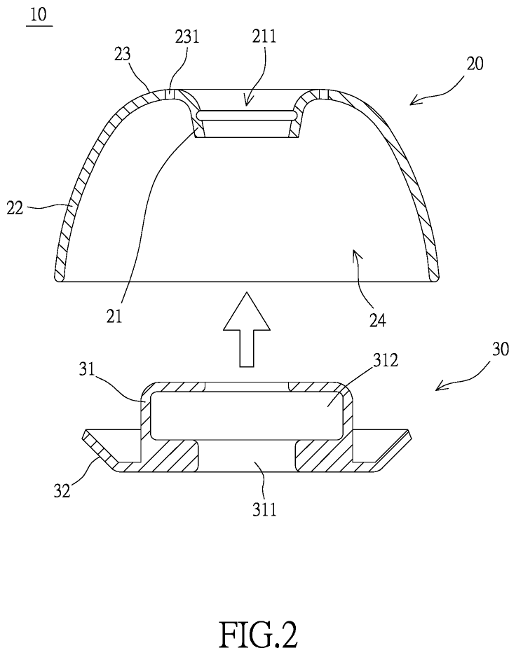

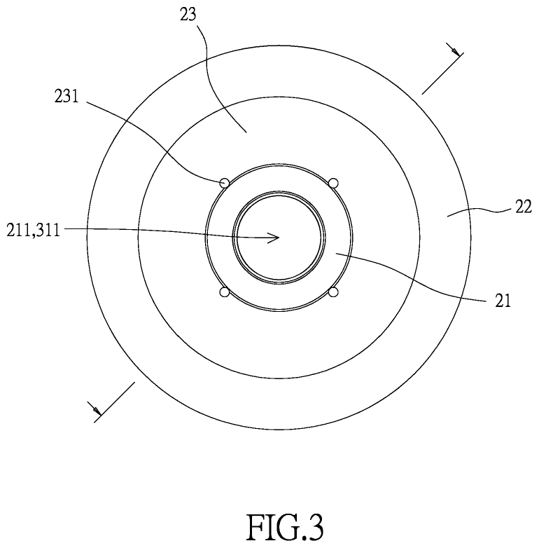

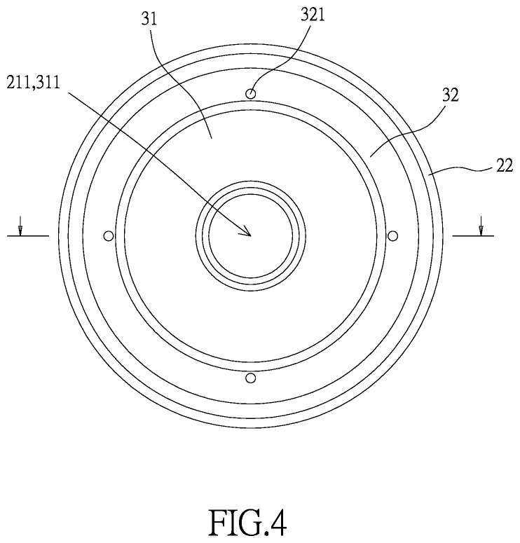

As shown in FIGS. 1 to 8, the present invention firstly provides an ear plug 10 having a pressure-adjusting compartment 11, wherein the ear plug 10 comprises an outer main body 20 and an inner main body 30 and is mounted on an earphone 40 for being placed into a human auditory canal 50.

The outer main body 20 has an audio out portion 21, an outer wall portion 22 and a connection portion 23. The audio out portion 21 is annular and has a first audio outlet 211 formed in the center thereof. The outer wall portion 22 is surroundingly provided around an outer side of the audio out portion 21, and the outer wall portion 22 has a length greater than a length of the audio out portion 21. The connection portion 23 is connected between the audio out portion 21 and the outer wall portion 22, and the connection portion 23 has thereon at least one first air conducting hole 231, such that the outer main body 20 has a hollow compartment 24 formed therein. In the present embodiment, the connection portion 23 is provided on one of edges of the audio out portion 21 and the outer wall portion 22, and the connection portion 23 is provided with four of the first air conducting holes 231, wherein the first air conducting holes 231 have a diameter between 0.1-1 mm.

The inner main body 30 is provided in the hollow compartment 24 of the outer main body 20, and has a mounting portion 31 and an umbrella portion 32. The mounting portion 31 is used to connect to the earphone 40 and is mutually connected to another end surface of the audio out portion 21, wherein the center of the mounting portion 31 has a second audio outlet 311 located in the same center as the first audio outlet 211, the second audio outlet 311 has therein a fixing groove 312, and the fixing groove 312 has a diameter greater than a diameter of the second audio outlet 311. The umbrella portion 32 is formed by outwardly extending the mounting portion 31, and the umbrella portion 32 is provided thereon with at least one second air conducting hole 321. In the present embodiment, the umbrella portion 32 has four of the second air conducting holes 321 provided thereon, and the center of each of the first air conducting holes 231 and the center of each of the second air conducting holes 321 are not located in the same center. In other words, each of the first air conducting holes 231 and each of the second air conducting holes 321 are mutually separated and provided in different positions, and each of the second air conducting holes 321 has a diameter between 0.1-1 mm. In addition, the umbrella portion 32 is provided on another edge of the mounting portion 31 connected to the audio out portion 21, and the umbrella portion 32 has an edge thereof mutually connected to the outer wall portion 22 of the outer main body 20, such that one of the pressure-adjusting compartment 11 communicated with the first air conducting holes 231 and the second air conducting holes 321 is formed between the outer main body 20 and the inner main body 30 by means of the audio out portion 21, the connection portion 23, the outer wall portion 22, the mounting portion 31 and the umbrella portion 32, and the pressure-adjusting compartment 11 has a volume between 10-100 microliters.

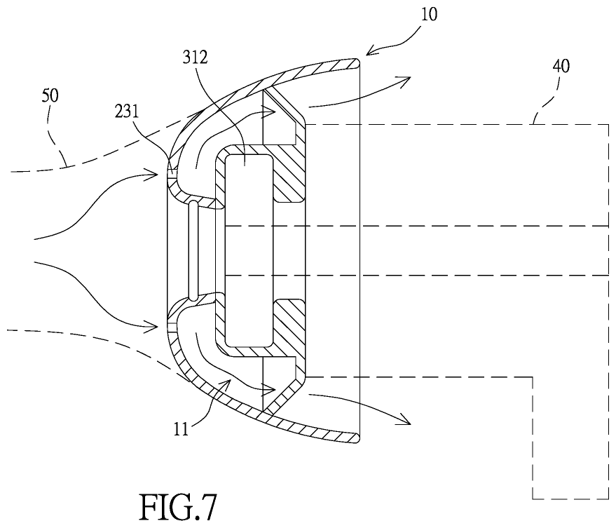

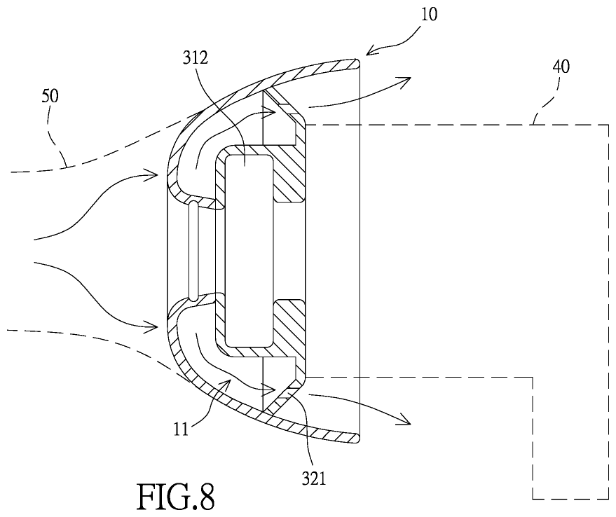

When the ear plug 10 is fixed on the earphone 40 via the mounting portion 31, the ear plug 10 can be securely integrated with the earphone 40 via the fixing groove 312; when the ear plug 10 is placed into the human auditory canal 50, an air pressure inside the human auditory canal 50 is greater than an air pressure outside the human auditory canal 50, which further enables air inside the human auditory canal 50 to enter into the pressure-adjusting compartment 11 via the first air conducting holes 231, and then released outside the ear plug 10 via the second air conducting holes 321 (the air flowing manner is indicated by the arrows in FIGS. 7 and 8). Accordingly, the flowing of air effectively reduces the air pressure inside the human auditory canal 50, and the design of separated positions of the first air conducting holes 231 and the second air conducting holes 321 enables the air entered into the pressure-adjusting compartment 11 to be temporarily stored in the pressure-adjusting compartment 11; the air temporarily stored inside the pressure-adjusting compartment 11 can be used to provide an effective supporting force for the outer wall portion 22, thereby enabling the outer wall portion 22 to be more closely fitted to an inner wall surface of the human auditory canal 50, and significantly improving wearing comfort.

In addition, when the earphone 40 is playing audio, in order to reduce interference from external noises to the audio inside the human auditory canal 50, the pressure-adjusting compartment 11 can also serve as a barrier against external sounds. Therefore, in order to prevent external sounds from entering into the human auditory canal 50, the first air conducting holes 231 and the second air conducting holes 321 have a diameter between 0.1-1 mm, and the pressure-adjusting compartment 11 has a volume between 10-100 microliters, such that a release time for the sounds inside the human auditory canal 50 can be controlled at below 0.05 second (20 Hz), which is the minimum hearing range for human ears, thereby forming a barrier against external bass sounds and improving sound quality of the earphone.

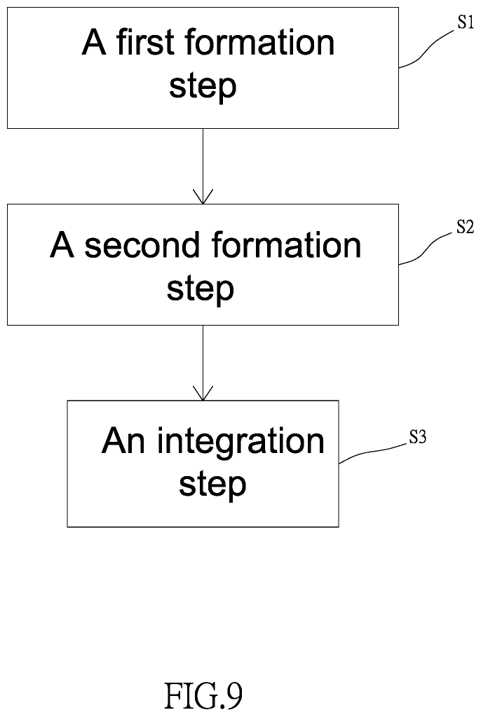

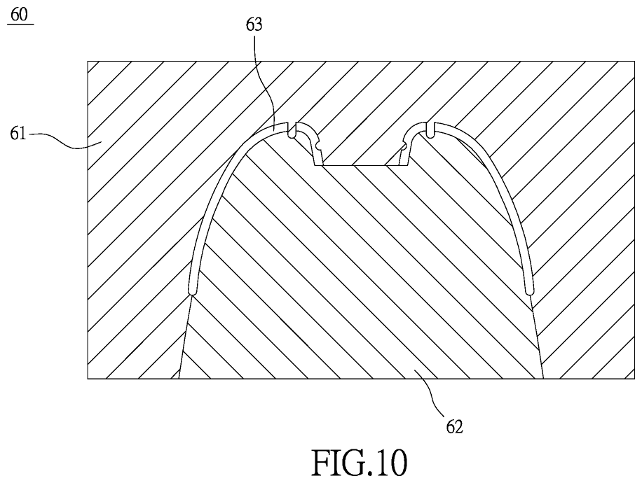

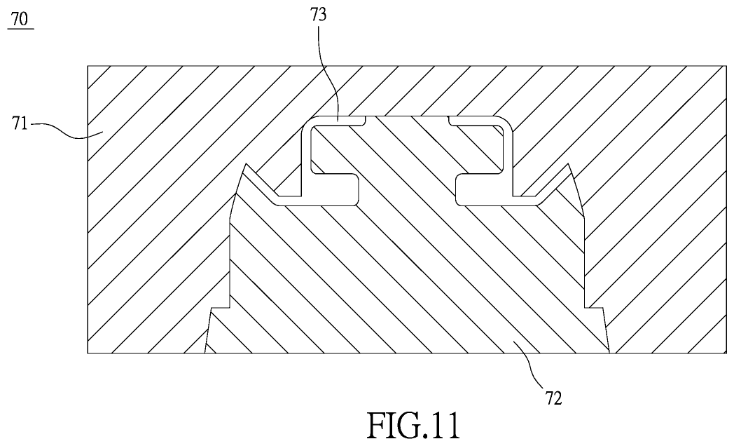

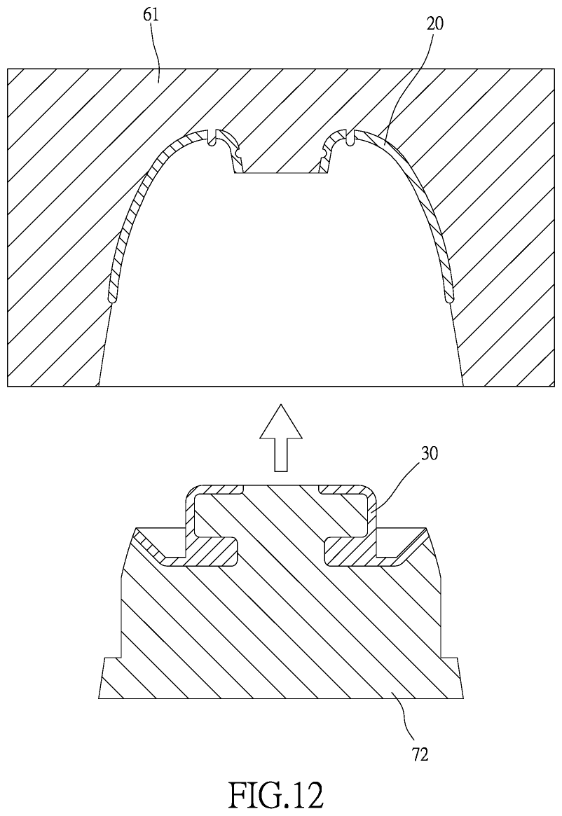

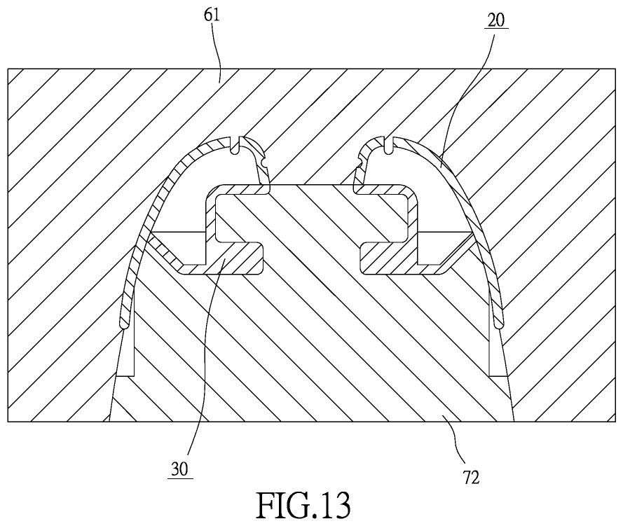

As shown in FIGS. 1 to 13, in order to form the pressure-adjusting compartment 11 on the ear plug 10, the present invention further provides a formation method for an ear plug 10, and the formation method comprises a first formation step S1, a second formation step S2 and an integration step S3. The first formation step 51 firstly provides a first mold 60, wherein the first mold 60 comprises a first upper mold base 61 and a first lower mold base 62, and a first formation space 63 is formed when the first upper mold base 61 and the first lower mold base 62 are closed, such that a formation material can be injected into the first formation space 63 so as to form the outer main body 20.

The second formation step S2 provides a second mold 70, wherein the second mold 70 is consisted of a second upper mold base 71 and a second lower mold base 72, and a second formation space 73 is formed when the second upper mold base 71 and the second lower mold base 72 are closed, such that the aforesaid formation material can be injected into the second formation space 73 so as to form the inner main body 30. It should be noted that in the present embodiment, the formation material is mainly based on silicone; silicone is firstly melted and then respectively injected into the first formation space 63 and the second formation space 73, thereby forming the outer main body 20 and the inner main body 30 by cooling.

The integration step S3 comprises: after respectively forming the outer main body 20 and the inner main body 30 in the first mold 60 and the second mold 70, firstly removing the first lower mold base 62 from the first mold 60, such that the outer main body 20 is kept inside the first upper mold base 61, and then removing the second upper mold base 71 from the second mold 70, such that the inner main body 30 is kept on the second lower mold base 72. Subsequently, the first upper mold base 61 and the second lower mold base 72 are closed, such that the mounting portion 31 is mutually joined with the audio out portion 21, and the umbrella portion 32 is mutually joined with the inner wall surface of the outer wall portion 22. Finally, secondary vulcanization is performed simultaneously on the outer main body 20 and the inner main body 30 inside the first upper mold base 61 and the second lower mold base 72, such that adjoining surfaces between the mounting portion 31 and the audio out portion 21, as well as between the umbrella portion 32 and the outer wall portion 22 can be mutually connected to each other, thereby forming the pressure-adjusting compartment 11 between the outer main body 20 and the inner main body 30, and constituting the ear plug 10; the ear plug 10 is then removed from the first upper mold base 61 and the second lower mold base 72, thereby forming the ear plug 10 having the pressure-adjusting compartment 11.

It should be noted that the outer main body 20 and the inner main body 30 are respectively formed by using silicone, and then mutually connected to form the pressure-adjusting compartment 11 by means of secondary vulcanization, and are respectively and mutually communicated with the first air conducting holes 231 and the second air conducting holes 321, while the outer main body 20 and the inner main body 30 are made of the same material and then both undergo secondary vulcanization, thus securely integrating the outer main body 20 with the inner main body 30, and significantly increasing the structural strength of the ear plug 10. Upon wearing, the ear plug 10 made of silicone is capable of improving comfort. By using the first air conducting holes 231, the second air conducting holes 321 and the pressure-adjusting compartment 11, the air inside the human auditory canal 50 can be released to achieve balancing of air pressures, or the air can be temporarily kept inside the pressure-adjusting compartment 11, so as to provide a supporting force for the outer wall portion 22 and enable the outer wall portion 22 to be more closely fitted to the human auditory canal 50.

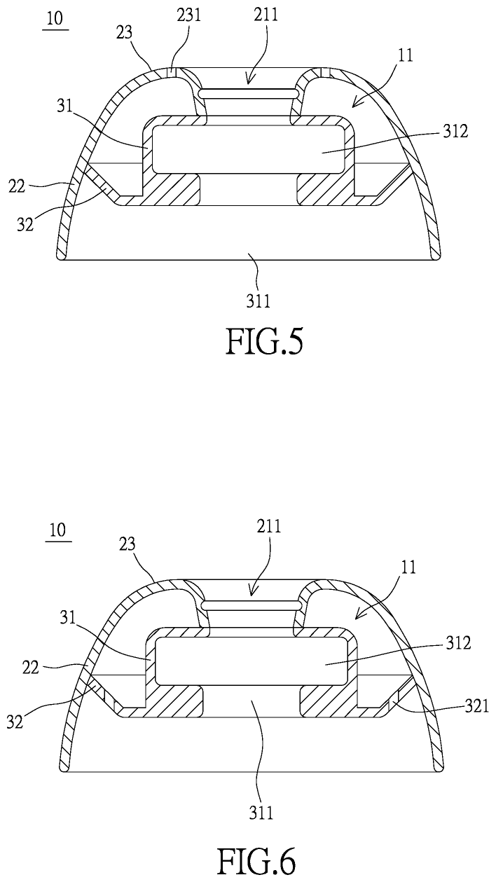

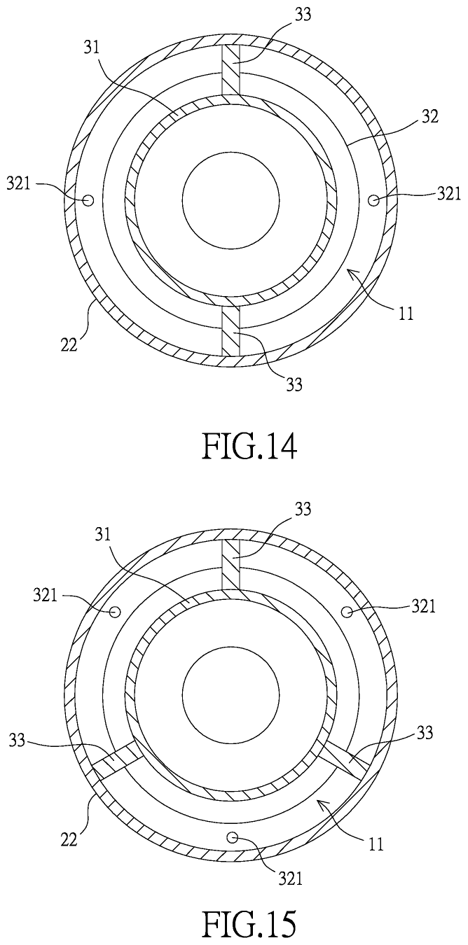

Alternatively, as shown in FIGS. 5, 6 and 14, in the present embodiment, the umbrella portion 32 is further provided with two corresponding partitions 33, and each of the partitions 33 is respectively extended towards an internal portion of the pressure-adjusting compartment 11 from the umbrella portion 32, and respectively and mutually connected to the mounting portion 31, the audio out portion 21, the outer wall portion 22 and the connection portion 23, thereby dividing the pressure-adjusting compartment 11 into two independent compartments by means of the two partitions 33, and each of the independent compartments is respectively and mutually communicated with at least one of the first air conducting holes 231 and at least one of the second air conducting holes 321.

Lastly, as shown in FIGS. 5, 6 and 15, in the present embodiment, the umbrella portion 32 is further provided with three corresponding partitions 33, and each of the partitions 33 is respectively extended towards an internal portion of the pressure-adjusting compartment 11 from the umbrella portion 32, and respectively and mutually connected to the mounting portion 31, the audio out portion 21, the outer wall portion and the connection portion 23, thereby dividing the pressure-adjusting compartment 11 into three independent compartments by means of the three partitions 33, and each of the independent compartments is respectively and mutually communicated with at least one of the first air conducting holes 231 and at least one of the second air conducting holes 321.

Therefore, by providing different quantities of the partition 33 so as to divide the pressure-adjusting compartment 11 into a plurality of independent compartments, and enabling each of the independent compartments to be respectively and mutually communicated with at least one of the first air conducting holes 231 and at least one of the second air conducting holes 321, each of the independent compartments is capable of adjusting air pressures individually.

In summary, the present invention has satisfied the requirement for an invention patent, and thus a patent application is filed accordingly. However, the described examples are merely preferred embodiments of the present invention, and cannot be used to limit the scope of claims of the present application. Any equivalent modifications or alterations made by persons skilled in the art according to the spirit of the present invention should be included in the scope of the following claims.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. An ear plug having a pressure-adjusting compartment, mounted on an earphone for being placed into a human auditory canal, the ear plug comprises:
an outer main body having an annular audio out portion, an outer wall portion enclosed around an outer side of the audio out portion and used for being fitted to the human auditory canal, and a connection portion connected between the audio out portion and the outer wall portion, such that the outer main body has a hollow compartment formed therein, and the connection portion has at least one first air conducting hole formed thereon; and
an inner main body provided in the hollow compartment of the outer main body, wherein the inner main body has a mounting portion for connecting to the earphone and an umbrella portion outwardly extended from the mounting portion and enclosed around an outer side of the mounting portion, and the umbrella portion has at least one second air conducting hole formed thereon;
wherein the mounting portion is mutually connected to an end surface of the audio out portion adjacent thereto, and the umbrella portion has an end surface thereof mutually connected to an inner wall surface of the outer wall portion, such that at least one pressure-adjusting compartment respectively and mutually communicated with the first air conducting hole and the second air conducting hole is formed between the outer main body and the inner main body; when the ear plug is inserted into the human auditory canal, the ear plug is capable of balancing an air pressure inside the human auditory canal with the external air pressure sequentially via the first air conducting hole, the pressure-adjusting compartment and the second air conducting hole.

2. The ear plug having a pressure-adjusting compartment of claim 1, wherein the audio out portion has a first audio outlet formed in the center thereof, the mounting portion has thereon a second audio outlet located in the same center as the first audio outlet, the second audio outlet has a fixing groove formed therein, and the fixing groove has a diameter greater than a diameter of the second audio outlet.

3. The ear plug having a pressure-adjusting compartment of claim 2, wherein the umbrella portion is further provided thereon with at least two partitions extended towards an internal portion of the pressure-adjusting compartment, and each of the partitions is respectively connected to the mounting portion, the audio out portion, the connection portion and the outer wall portion, thereby dividing the pressure-adjusting compartment into two independent compartments by means of the two partitions, and each of the independent compartments is respectively and mutually communicated with at least one of the first air conducting holes and at least one of the second air conducting holes.

4. The ear plug having a pressure-adjusting compartment of claim 1, wherein the first air conducting hole and the second air conducting hole are not located in the same center, such that the first air conducting hole and the second air conducting hole are mutually separated from each other.

5. The ear plug having a pressure-adjusting compartment of claim 1, wherein the first air conducting hole and the second air conducting hole have a diameter between 0.1-1 mm, and the pressure-adjusting compartment has a volume between 10-100 microliters.

6. A formation method for forming a pressure-adjusting compartment on an ear plug, comprising steps of:
a) a first formation step for forming an outer main body, firstly providing a first mold having a first upper mold base and a first lower mold base; forming a first formation space inside the first mold; forming the outer main body after injecting a formation material into the first formation space, such that the outer main body has an annular audio out portion, an outer wall portion enclosed around an outer side of the audio out portion and used for being fitted to the human auditory canal and a connection portion connected between the audio out portion and the outer wall portion, wherein the outer main body has a hollow compartment formed therein, and the connection portion has at least one first air conducting hole formed thereon;
b) a second formation step for forming an inner main body, further providing a second mold having a second upper mold base and a second lower mold base; forming a second formation space inside the second mold; forming the inner main body after injecting a formation material into the second formation space, such that the inner main body has a mounting portion and an umbrella portion outwardly extended from the mounting portion and enclosed around an outer side of the mounting portion, wherein the umbrella portion has at least one second air conducting hole formed thereon; and
c) an integration step for firstly removing the first lower mold base, thereby keeping the outer main body on the first upper mold base; removing the second upper mold base, thereby keeping the inner main body on the second lower mold base; subsequently closing the first upper mold base with the second lower mold base, such that mutually adjacent end surfaces of the audio out portion and the mounting portion are mutually joined, wherein the umbrella portion has one end surface thereof mutually joined with an inner wall surface of the outer wall portion, so as to form at least one of the pressure-adjusting compartment respectively and mutually communicated with the first air conducting hole and the second air conducting hole between the outer main body and the inner main body, and the ear plug is formed by means of the outer main body and the inner main body.

7. The formation method for forming a pressure-adjusting compartment on an ear plug of claim 6, wherein the formation material is silicone.

8. The formation method for forming a pressure-adjusting compartment on an ear plug of claim 6, wherein in the integration step, the audio out portion, the mounting portion, the umbrella portion and the inner wall surface are mutually joined by means of secondary vulcanization.

9. The formation method for forming a pressure-adjusting compartment on an ear plug of claim 6, wherein the first air conducting hole and the second air conducting hole are not located in the same center, such that the first air conducting hole and the second air conducting hole are mutually separated from each other.

10. The formation method for forming a pressure-adjusting compartment on an ear plug of claim 9, wherein the first air conducting hole and the second air conducting hole have a diameter between 0.1-1 mm, and the pressure-adjusting compartment has a volume between 10-100 microliters.
